(19) United States
(12) Patent Application Publication
(10) Pub. No.: US 2004/0163324 A1
(43) Pub. Date: Aug. 26, 2004

(54) CMP slurry polysilicon and method of forming semiconductor device using the same

(76) Inventors: Sang Ick Lee, Kyoungki-do (KR); Hyung Hwan Kim, Kyoungki-do (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/334,295

(22) Filed: Dec. 31, 2002

(30) Foreign Application Priority Data
May 17, 2002 (KR) 2002-27540

(51) Int. Cl. C09K 3/14

(52) U.S. Cl. 51/306

(57) ABSTRACT

A Chemical Mechanical Polishing(abbreviated as “CMP”) slurry composition for polysilicon and method of forming a self-aligned floating gate of a flash memory device are disclosed for performing CMP process using slurry having higher polishing selectivity to polysilicon than to isolation oxide film which is an etching barrier film.

### BACKGROUND

1. Technical Field

A Chemical Mechanical Polishing(abbreviated as “CMP”) slurry composition for polysilicon and a method of forming a self-aligned floating gate of a flash memory device are disclosed for performing CMP process using slurry having higher polishing selectivity to polysilicon than to isolation oxide film which is an etching barrier film.

2. Description of the Related Art

Flash memory is a memory wherein a programming and an erasing operation are simultaneously performed while electrons are passing through a tunnel oxide film formed between a self-aligned floating gate and a semiconductor substrate. Flash memory is also a nonvolatile memory wherein stored information is not damaged even when power is turned off and the information can be freely inputted/outputted by an electrical method.

FIGS. 1a through 1g are diagrams illustrating processes of fabricating conventional self-aligned floating gate. The reader will note that the thicknesses listed for the various layers are approximations.

Referring to FIG. 1a, a pad oxide film 3 is formed at a thickness of 100 Å on a silicon substrate 1, and a pad nitride film 5 is sequentially formed at a thickness of 2500 Å above the pad oxide film 3.

Referring to FIG. 1b, while a selective polishing process using mask(not shown) is performed on the resultant structure, the pad nitride film 5 at a thickness of 2500 Å, the pad oxide film 3 at a thickness of 100 Å and the silicon substrate 1 at a thickness of 3000 Å are sequentially removed. As a result, a pad nitride film pattern 5-1, a pad oxide film pattern 3-1 and a trench 7 are formed.

Referring to FIG. 1c, an isolation oxide film 9 is formed at a thickness of 6000 Å on the entire surface including the trench 7.

Referring to FIG. 1d, a CMP process using the conventional CMP slurry for oxide film is performed on the isolation oxide film 9 using the pad nitride film pattern 5-1 as etching barrier film, thereby an active region 11 is isolated.

Referring to FIG. 1e, the pad nitride film pattern 5-1 and the pad oxide film pattern 3-1 are selectively wet-etched until the substrate 1 is exposed, and then a tunnel oxide film 13 is formed on the exposed substrate 1.

Referring to FIG. 1f, polysilicon 15a is stacked on the tunnel oxide film 13 and isolation oxide film 9 at a thickness of 1700 Å with respect to the isolation oxide film 9.

Referring to FIG. 1g, the polysilicon 15a is polished using a slurry for polysilicon until the isolation oxide film 9 is exposed to provide a floating gate 15.

Because general slurry for oxide films are used as the slurry for polishing polysilicon, the general slurry including abrasives such as CeO₂ or SiO₂, the isolation oxide film 9 serving as an etching barrier film is polished with the polysilicon 15a.

As a result, it is difficult to measure an approximate end point for the polishing process. In addition, because the isolation oxide film 9 is formed with a greater thickness than required, the process cost is unnecessarily increased.

### SUMMARY OF THE INVENTION

A CMP slurry having a better polishing selectivity to polysilicon than to oxide films is disclosed.

The disclosed slurry improves the reliability of the resulting device by forming a self-aligned floating gate of a flash memory device with an improved and more consistent system.

A disclosed CMP slurry composition for polysilicon comprises a solvent, an abrasive and an additive.

The additive comprises at least one of ammonium hydroxide and amine compound, the amine compound having a functional group selected from the group consisting of —N(OH), —NH(OH) and —NH₂(OH), wherein the composition has a pH ranging from 8 to 11.

The CMP slurry composition further comprises a pH adjusting agent. The pH adjusting agent is phosphoric acid, and is added to maintain the pH ranging from 8 to 11, more desirably from 10 to 11, thereby improving the selectivity to polysilicon.

Accordingly, the amount of adding phosphorous is not specifically predetermined, but the proper amount is determined to maintain the above pH range of the slurry composition.

The solvent is distilled water or ultra pure water and the abrasive is SiO₂.

The additive is selected from the group consisting of tetramethyl ammonium hydroxide, tetraethyl ammonium hydroxide, tetrabuthyl ammonium hydroxide, dimethylamine, methylamine and combinations thereof.

The additive is present in amount of 0.5 to 5 weight parts based on 100 weight parts of the solvent.

The abrasive is present in amount of 0.6 to 12, more preferably from 0.6 to 10, weight parts based on 100 weight parts of the solvent.

The CMP slurry composition for polysilicon has a polishing selectivity of oxide film:polysilicon ranging from 1:50 to 1:300, more preferably from 1:100 to 1:300.

One disclosed method comprises:

(a) forming a pad oxide film pattern including a tunnel oxide film on the substrate;

(b) forming a polysilicon on the resultant surface; and

(c) performing a CMP process on to the resultant using the CMP slurry composition of the present invention until the pad oxide film pattern is exposed.

### BRIEF DESCRIPTION OF THE DRAWINGS

FIGS. 1a through 1g are cross-sectional diagrams illustrating method of fabricating flash memory device according to the prior art.

FIGS. 2a through 2c are cross-sectional diagrams illustrating method of fabricating flash memory device using the disclosed methods and slurries.

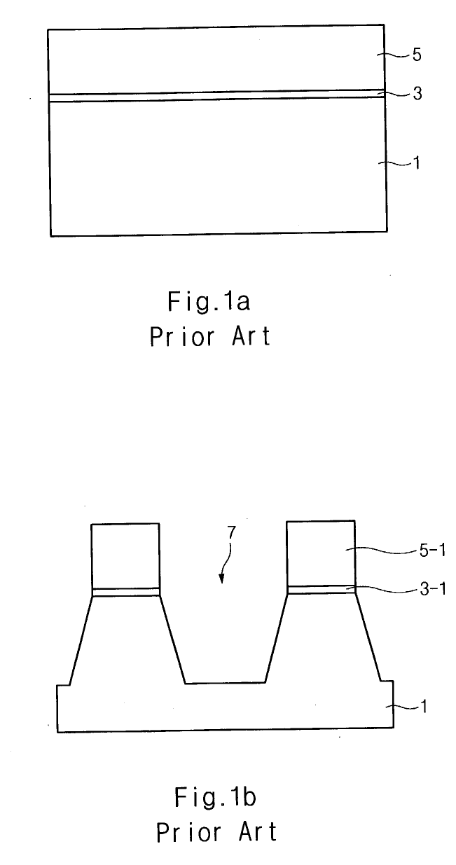

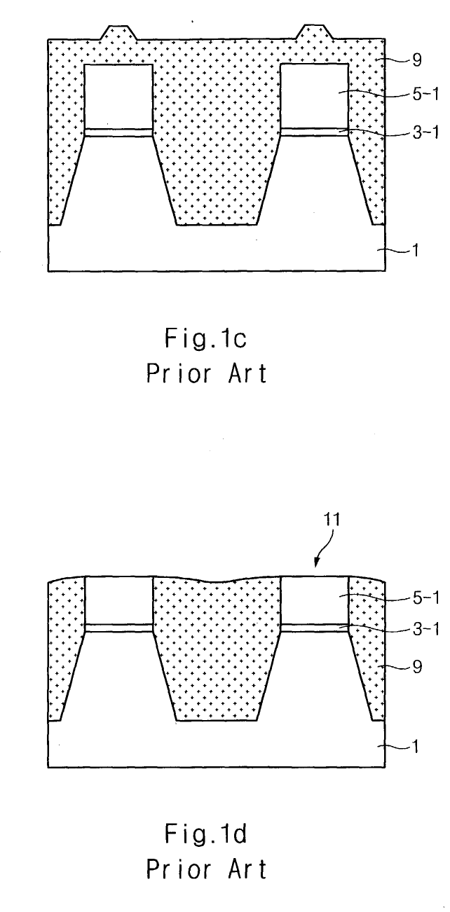

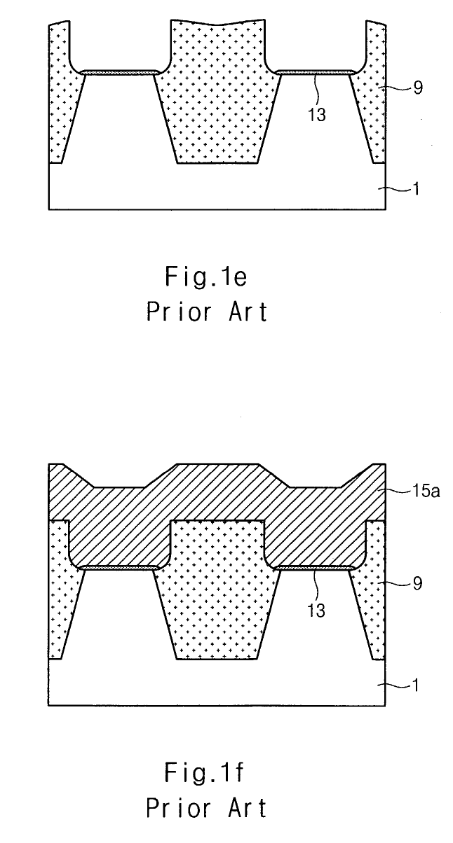

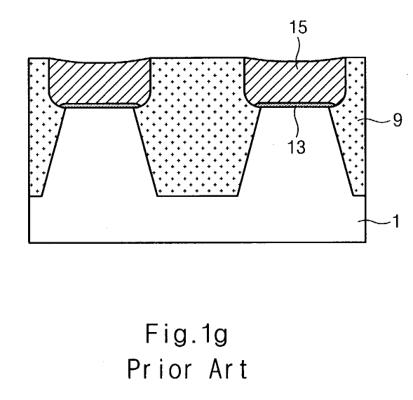

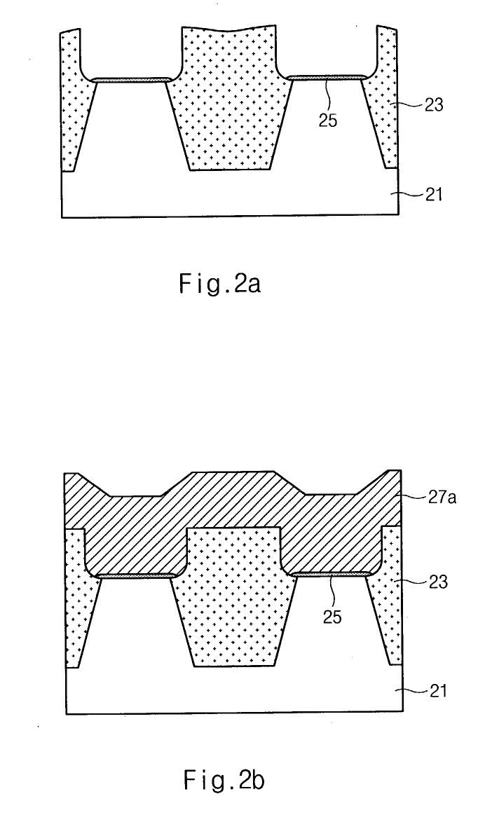

### DETAILED DESCRIPTION OF THE PRESENTLY PREFERRED EMBODIMENTS

Methods of fabricating semiconductor device will now be described in more detail in reference to the accompanying drawings. Again, it will be noted that the thicknesses of the various layers described below are more approximations and the actual thicknesses may vary without departing from the scope of this disclosure.

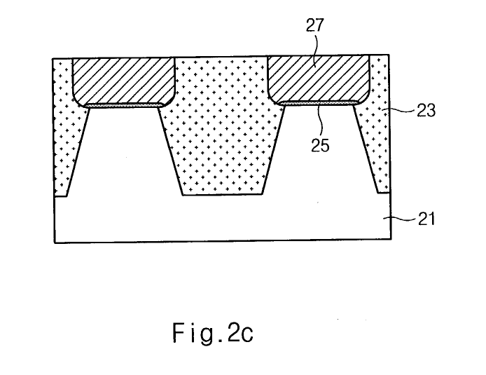

FIGS. 2a through 2g are diagrams illustrating methods of fabricating flash memory devices in accordance with a preferred embodiment.

First, a pad oxide film(not shown) and a pad nitride film(not shown) are sequentially formed on the silicon substrate 21, and then the pad oxide film(not shown), the pad nitride film(not shown) and the silicon substrate(not shown) 21 in the above stacked structure are sequentially removed using a selective polishing method.

As a result, a pad oxide film pattern(not shown), a pad nitride film pattern(not shown) and a trench is formed.

A isolation oxide film 23 is formed on the entire surface of the resultant structure, and then a CMP process is performed using general slurry for oxide films on the isolation oxide film 23 until the pad nitride film pattern is exposed, thereby an active region is isolated.

Referring to FIG. 2a, the pad nitride film pattern(not shown) and the pad oxide film pattern(not shown) are selectively wet-etched until the substrate 21 is exposed, and then a tunnel oxide film 25 is formed on the exposed portions of substrate 21.

Referring to FIG. 2b, polysilicon 27a is formed at a thickness of 1300 to 1700 Å above the tunnel oxide film 25.

Referring to FIG. 2c, the polysilicon 27a is polished until the isolation oxide film 23 is exposed using a disclosed slurry for polysilicon.

Then, lower electrodes of floating gate 27 are formed.

Accordingly, the damage of isolation oxide film 9 during the CMP process using the disclosed slurry for polysilicon can be prevented. As a result, the process cost and thickness difference of film can be reduced, thereby improving reliability of device.

### EXAMPLE 1

### Fabricating Slurry for Polysilicon

According to the quantities of Table 1, SiO₂ as abrasive is added in ultra pure water, stirred not to be condensed, and then tetramethyl ammonium hydroxide(CAS#75-59-2) as additive is further added in the ultra pure water.

While the compound is stirred, phosphoric acid as a pH adjusting agent is added in the compound to maintain pH 10. The compound is further being stirred for about 30 minutes until it becomes completely mixed and stabilized. As a result, the disclosed slurry has a high selectivity to oxide films.

TABLE 1

| | | | Ammonium Hydroxide |
|---|---|---|---|
| | SiO₂ | Ultra Pure Water | or Amine |
| A | 112 g | 1000 g | 6 g |
| B | 53 g | 1000 g | 5 g |
| C | 10 g | 1000 g | 5 g |

### EXAMPLE 2

### Polishing Selectivity of Slurry for Polysilicon

Using the slurry composition of the example 1, a CMP process is performed on polysilicon films ‘poly-Si’ and silicon oxide films ‘Ox’, respectively, at a head pressure and a polishing pressure of 5 psi, and at a table rotation frequency of 30 rpm. Table 2 shows the polishing amount and selectivity as a result of the CMP process.

TABLE 2

| | Polishing Amount of | Polishing Selectivity |
|---|---|---|
| | Polysilicon (Poly-Si, Å/min) | (Poly-Si/Ox) |
| A | 10,000 | 50 |
| B | 6,000 | 100 |
| C | 4,500 | 300 |

As discussed earlier, the disclosed slurry provides remarkably improved selectivity as opposed to conventional slurries. If polysilicon is polished using the slurry having the improved selectivity, it is possible to prevent isolation oxide film from being polished with polysilicon, to measure a precise end point, and to reduce thickness differences of films to be polished. Accordingly, reliability of a device can be improved by forming uniform polysilicon on the whole surface of a wafer.

What is claimed is:

1. A CMP slurry composition for polysilicon comprising:
a solvent, an abrasive and an additive,
the additive comprising at least one of ammonium hydroxide and amine compound, the amine compound having a functional group selected from the group consisting of —N(OH), —NH(OH) and —NH₂(OH),
wherein the composition has pH ranging from 8 to 11.

2. The CMP slurry composition according to claim 1, wherein the composition has pH ranging from 10 to 11.

3. The CMP slurry composition according to claim 1, wherein the composition further comprises a phosphoric acid as a pH adjusting agent.

4. The CMP slurry composition according to claim 1, wherein the additive is selected from the group consisting of tetramethyl ammonium hydroxide, tetraethyl ammonium hydroxide, tetrabutyl ammonium hydroxide, dimethylamine methylamine, and combinations thereof.

5. The CMP slurry composition according to claim 1, wherein the additive is present in amount ranging from 0.5 to 5 weight parts based on 100 weight parts of the solvent.

6. The CMP slurry composition according to claim 1, wherein the abrasive is SiO₂.

7. The CMP slurry composition according to claim 1, wherein the abrasive is present in amount ranging from 0.6 to 12 weight parts based on 100 weight parts of the solvent and the additive is present in amount ranging from 0.5 to 5 weight parts based on 100 weight parts of the solvent.

8. The CMP slurry composition according to claim 1, wherein a polishing selectivity ratio of the slurry composition for oxide film:polysilicon ranges from 1:50 to 1:300.

9. The CMP slurry composition according to claim 1, wherein a polishing selectivity ratio of the slurry composition for oxide film:polysilicon ranges from 1:100 to 1:300.

10. A method of forming a semiconductor device, comprising the steps of:
(a) forming a pad oxide film pattern including a tunnel oxide film on a substrate;
(b) forming a polysilicon layer on the pad oxide film pattern and tunnel oxide film; and
(c) performing a CMP process on the polysilicon layer using the CMP slurry composition of claim 1 until the pad oxide film pattern is exposed.
